(19) United States
(12) Patent Application Publication
(10) Pub. No.: US 2024/0033731 A1
(43) Pub. Date: Feb. 1, 2024

(54) TEST APPARATUS

(71) Applicant: KONICA MINOLTA, INC., Tokyo (JP)

(72) Inventors: Kengo FUSHIYA, Tokyo (JP); Dai SUWAMA, Tokyo (JP)

(21) Appl. No.: 18/210,612

(22) Filed: Jun. 15, 2023

(30) Foreign Application Priority Data
Aug. 1, 2022 (JP) 2022-122469

(51) Int. Cl. B01L 3/00; G01N 21/64

(52) U.S. Cl. CPC B01L 3/502715; G01N 21/6428; B01L 2300/0654; B01L 2300/0803; B01L 2200/16; B01L 2300/0609; B01L 2200/025; B01L 2400/0457

(57) ABSTRACT

A test apparatus includes a holder that is capable of holding a test container in which a test object is to be provided, an optical measurement section that performs predetermined processing on the test object of the test container held by the holder, and a hardware processor that controls holding of the test container by the holder and releasing of the holding. In this test apparatus, the test container released from the holding moves in a gravity direction.

### CROSS-REFERENCE TO RELATED APPLICATION

The entire disclosure of Japanese Patent Application No. 2022-122469 filed on Aug. 1, 2022, including description, claims, drawings, and abstract is incorporated herein by reference in its entirety.

### BACKGROUND

### Technological Field

The present invention relates to a test apparatus.

### Description of the Related art

In recent years, a test for detecting viruses and the like from saliva, a nasal swab, or the like of a subject has attracted attention. Techniques for automating this test have also been proposed. For example, Japanese Unexamined Patent Publication No. 2011-252735 and Japanese Unexamined Patent Publication No. H8-228759 disclose the techniques.

### SUMMARY

As described above, automation of such a test has been promoted. However, when a test operator who is unfamiliar with handling of a test object such as a biological sample performs a test, there is a concern about a risk of infection to the test operator. An inexperienced test operator may carelessly touch a test container, particularly when the test container to which the test object is attached is discarded after the test. Therefore, it is desirable that the test container can be discarded without being touched by the test operator.

The present invention has been made in view of the above circumstances. An object of the present invention is to provide a test apparatus capable of discarding a test container without being touched by a test operator.

The above object of the present invention is achieved by the following.

(1) A test apparatus including a holder that is capable of holding a test container in which a test object is to be provided, a processing section that performs predetermined processing on the test object in the test container held by the holder, and a hardware processor that controls holding of the test container by the holder and releasing of the holding, in which the test container released from the holding moves in a gravity direction.

### BRIEF DESCRIPTION OF THE DRAWINGS

The advantages and features provided by one or more embodiments of the present invention will become more fully understood from the detailed description given hereinbelow and the appended drawings which are given by way of illustration only, and thus are not intended as a definition of the limits of the present invention.

FIG. 1 is a schematic diagram illustrating an example of a configuration of a test apparatus according to an embodiment;

FIG. 2 is a diagram illustrating an example of a planar configuration of the test apparatus illustrated in FIG. 1;

FIG. 3 is a schematic diagram illustrating another example of a position of a placement base illustrated in FIG. 1;

FIG. 4 is a diagram illustrating an example of a configuration of a lower end portion of a holder illustrated in FIG. 1;

FIG. 5 is a diagram illustrating an example of a cross-sectional configuration of a test container illustrated in FIG. 2;

FIGS. 6A to 6D are schematic diagrams sequentially illustrating an example of operations of the test apparatus illustrated in FIG. 1; and

FIGS. 7A and 7B are schematic diagrams sequentially illustrating an example of operations subsequent to FIGS. 6A to 6D.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of a test apparatus according to the present invention will be described with reference to the appended drawings. Note that in the drawings, the same reference numerals are used for the same members. In addition, dimensional ratios in the drawings are exaggerated for convenience of description and may be different from actual ratios.

### Embodiment

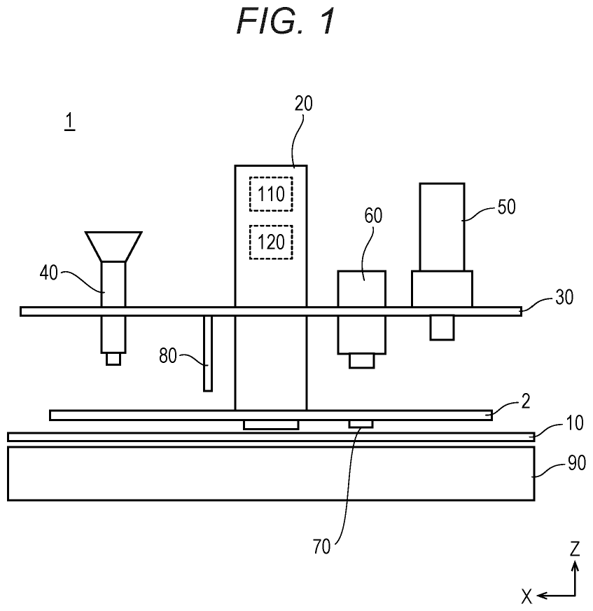

FIG. 1 illustrates an example of an overall configuration of a test apparatus 1 according to an embodiment of the present invention together with a test container 2. This test apparatus 1 supplies a test object such as a biological sample and a reagent to the test container 2, and performs optical measurement of a reaction product between the test object and the reagent.

The test apparatus 1 includes, for example, a placement base 10, a holder 20, a support base 30, a test object supply section 40, and a reagent supply section 50. The test apparatus 1 further includes an optical measurement section 60, a maintaining member 70, a releasing member 80, a discarding section 90, a driver 110, and a controller 120. In the test apparatus 1, the support base 30, the placement base 10, and the discarding section 90 are provided in this order from the top. In the test apparatus 1, the holder 20 extends in an up-down direction of the test apparatus 1. The test container 2 is disposed between the placement base 10 and the support base 30. The test apparatus 1 disposes the test container 2 at this position and performs optical measurement. Hereinafter, the up-down direction of the test apparatus 1 may be referred to as a Z direction, and directions perpendicular to the Z direction may be referred to as an X direction and a Y direction.

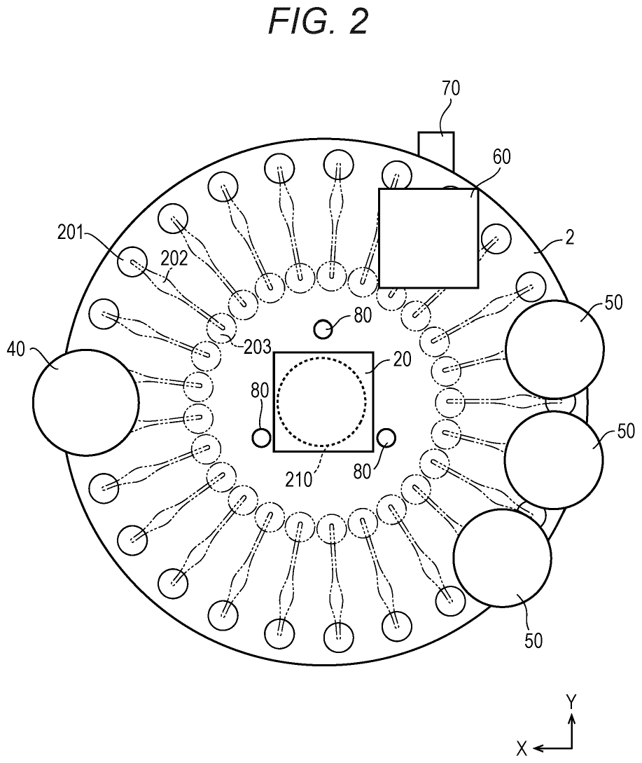

FIG. 2 illustrates an example of a configuration of an XY plane of the test apparatus 1 and the test container 2. The test container 2 has, for example, a circular planar shape, that is, a disc shape. The planar shape of the test container 2 is, for example, a shape of the XY plane. For example, the test container 2 is configured to be able to test a plurality of test objects. Hereinafter, the configurations of the test apparatus 1 and the test container 2 will be described with reference to FIGS. 1 and 2.

### Configuration of Test Apparatus 1

The placement base 10 has a placement surface on which the test container 2 is to be placed. The placement surface may be referred to as an upper surface. For example, a test operator places the test container 2 on the placement surface. The placement surface is, for example, an XY plane. An area of the placement surface is larger than an area of the XY plane of the test container 2. A planar shape of the placement surface is, for example, a quadrangle. The placement base 10 is configured to be displaceable in, for example, the X direction and the Y direction. The placement base 10 moves between a position facing the holder 20 and a position not facing the holder 20.

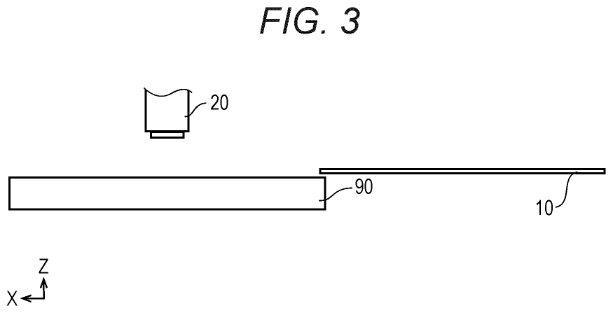

FIG. 3 illustrates the placement base 10 disposed at the position not facing the holder 20. At this time, it is preferable that the placement base 10 is disposed, for example, at a position not overlapping the discarding section 90 in plan view. Accordingly, the test container 2 held by the holder 20 can be easily discarded to the discarding section 90. This plan view is an XY plan view. For example, the placement base 10 is displaced in the X direction and the Y direction by being driven by a motor or the like.

The holder 20 extending in the Z direction is configured to be capable of holding the test container 2. The holder 20 holds the test container 2 placed on the placement base 10, for example, based on an instruction from the controller 120. The holder 20 holds, for example, the test container 2 in an axially rotatable manner. The test container 2 held by the holder 20 rotates clockwise or counterclockwise along the XY plane around a hole portion. A specific example of the hole portion is a hole portion 210 to be described later.

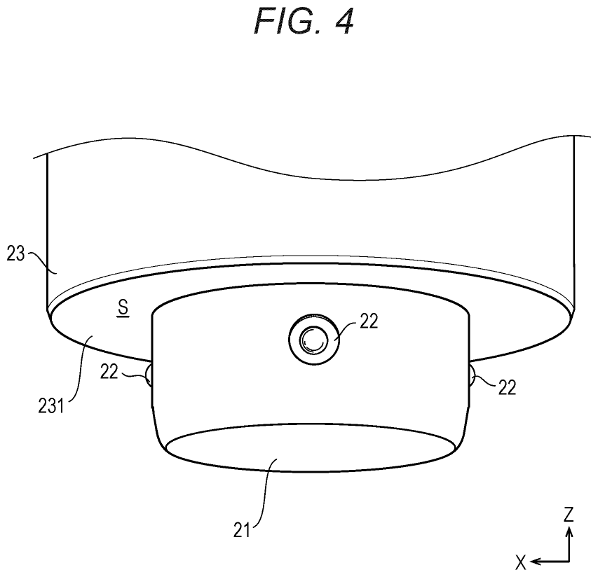

FIG. 4 illustrates a configuration of a lower end portion of the holder 20. The holder 20 includes a shaft member 21, a support member 22, and an exterior member 23. The shaft member 21 is inserted through the hole portion of the test container 2. The holder 20 holds, between the support member 22 and the exterior member 23, the test container 2 through which the shaft member 21 is inserted. Here, the exterior member 23 corresponds to a specific example of a counter member of the invention of the present application.

The shaft member 21 has a cylindrical shape extending in the Z direction. The shaft member 21 is configured to be axially rotatable. The test container 2 is rotated by axial rotation of the shaft member 21. Here, the Z direction corresponds to a specific example of an axial direction of the invention of the present application. The Z direction is also referred to as an up-down direction.

The support member 22 is provided on a peripheral surface of the shaft member 21. The support member 22 is configured to be able to protrude from the peripheral surface of the shaft member 21. The support member 22 includes, for example, a plunger such as a ball plunger and a pin plunger. When a load is applied to the support member 22, the support member 22 is accommodated inward from the peripheral surface of the shaft member 21. When the load is released from the support member 22, the support member 22 protrudes from the peripheral surface of the shaft member 21. The support member 22 protruding from the peripheral surface of the shaft member 21 is in contact with a lower surface of the test container 2 and supports the test container 2. It is preferable that a plurality of support members 22 are provided in a rotation direction of the shaft member 21. It is preferable that the plurality of support members 22 are disposed at rotationally symmetrical positions. In FIG. 4, three support members 22 are disposed at rotationally symmetrical positions with respect to the shaft member 21. Thus, the test container 2 can be supported more stably.

The exterior member 23 has a cylinder shape for accommodating the shaft member 21. That is, an outer diameter of the exterior member 23 is larger than an outer diameter of the shaft member 21. The exterior member 23 extends in the Z direction. The exterior member 23 has an end surface S on a placement base 10 side. An end portion of the shaft member 21 and the support member 22 provided at the end portion of the shaft member 21 are exposed from the end surface S. The end surface S is, for example, an XY plane. The end surface S faces the support member 22 protruding from the peripheral surface of the shaft member 21. In other words, the end surface S faces the support member 22 with the test container 2 through which the shaft member 21 is inserted interposed therebetween. At this time, the upper surface of the test container 2 is in contact with the end surface S. That is, the test container 2 is held between the support member 22 and the end surface S of the exterior member 23. In this embodiment, the end surface S corresponds to a specific example of an opposite surface of the invention of the present application.

For example, an elastic layer 231 is provided on the end surface S. The elastic layer 231 is in contact with the upper surface of the test container 2. The elastic layer 231 includes, for example, a rubber-based material. By providing the elastic layer 231 on the end surface S, the test container 2 is less likely to slip when the test container 2 held by the holder 20 rotates. Therefore, it becomes easier to accurately control the rotation of the test container 2.

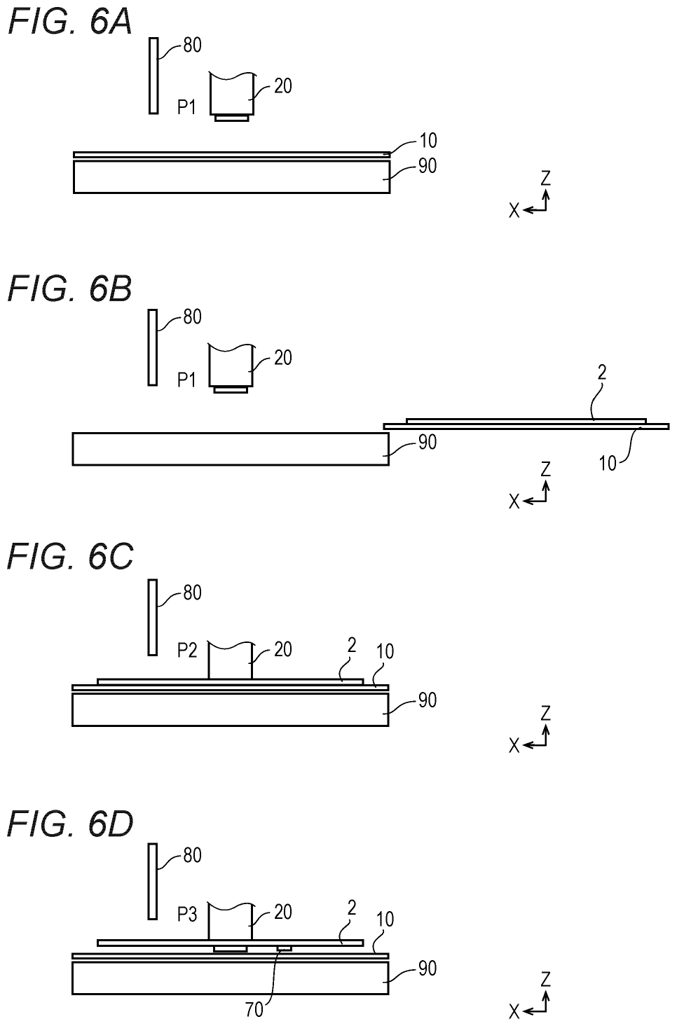

The holder 20 including the shaft member 21, the support member 22, and the exterior member 23 is configured to be movable in the Z direction. The holder 20 moves, for example, between a first position on a support base 30 side and a second position on the placement base 10 side in the Z direction. A specific example of the first position is a first position P1 in FIG. 6A to be described later. A specific example of the second position is a second position P2 of FIG. 6C to be described later. For example, the holder 20 holds the test container 2 at the second position. The holder 20 further moves to a third position between the first position and the second position. A specific example of the third position is a third position P3 in FIG. 6D to be described later. At the third position, the test object provided in the test container 2 is tested. Thereafter, the holder 20 moves to the first position, and the test container 2 is discarded at the first position.

The support base 30 facing the placement base 10 supports the test object supply section the reagent supply section 50, and the optical measurement section 60. The support base 30 includes, for example, a plate member. The test object supply section 40, the reagent supply section 50, and the optical measurement section 60 are inserted in openings provided in the plate member. The test container 2 is disposed between the support base 30 and the placement base The test object provided in the test container 2 is tested. In this embodiment, the reagent supply section 50 and the optical measurement section 60 correspond to a specific example of a processing section of the invention of the present application.

The test object supply section 40 held by the support base 30 stores a predetermined amount of the test object. The test object stored in the test object supply section 40 is supplied to the test container 2. For example, the test object diluted with a diluent is stored in the test object supply section 40. The diluent is, for example, water. The test object supply section 40 is, for example, a substantially cylindrical container having a height in the Z direction. The test object supply section 40 has a supply port at an end portion in the Z direction.

The test object stored in the test object supply section 40 is, for example, a biological sample such as a body fluid collected from a mucosal portion of a subject. Specifically, the test object is a nasal swab, saliva, or the like. The test object may be a body fluid collected from a body fluid-moistened portion such as a wound. The test object may be collected directly from the subject or may be collected indirectly from the subject. The test object indirectly collected is collected from, for example, a doorknob or the like touched by the subject. It is preferable that the test object is collected non-invasively from the subject. The test object may be a sample other than the biological sample. The test object may be, for example, a chemical, environmental water, tap water, sewage, or the like. The test apparatus 1 performs, for example, optical measurement of a reaction product resulting from a reaction between a test target substance such as DNA, RNA, protein, a virus, or a bacterium included in the test object and a reagent to be described later.

The reagent supply section 50 stores a predetermined amount of the reagent. The reagent stored in the reagent supply section 50 is supplied to the test container 2. The reagent supply section 50 stores, for example, a reagent dispersed or dissolved in a solvent. The reagent supply section 50 is, for example, a substantially cylindrical container having a height in the Z direction. A supply port is provided at an end portion of the reagent supply section 50 in the Z direction. The reagent stored in the reagent supply section 50 is supplied to the test container 2 through the supply port. FIG. 2 illustrates an example in which the test apparatus 1 has three reagent supply sections 50. However, the test apparatus 1 may have one or two reagent supply sections 50. Alternatively, the test apparatus 1 may have four or more reagent supply sections 50.

The reagent stored in the reagent supply section 50 is, for example, a dye, a fluorescent substance, nanoparticles, or the like. The reagent forms a physical or chemical bond with the test target substance contained in the test object. As this reagent, a known reagent can be used. The fluorescent substance is, for example, a fluorescent dye, quantum dots, or the like. The nanoparticles are polystyrene beads, gold nanoparticles, or the like. For example, by bonding such a reagent to the test target substance, an optical signal generated at the time of light irradiation is increased. Thus, detection of the test target substance is facilitated. In particular, such a reagent is effective when the optical signal of the test target substance alone is weak. The reagent may be a substance that causes light absorption or light scattering. At this time, by bonding the reagent to the test target substance, the light intensity generated at the time of light irradiation is reduced, and the optical signal is amplified.

The bonding of the reagent and the test target substance is, for example, bonding by physical adsorption, bonding by an antigen-antibody reaction, or bonding by DNA hybridization. The bonding between the reagent and the test target substance is biotin-avidin bonding, chelate bonding, amino bonding, or the like. The bonding by physical adsorption is, for example, hydrogen bonding or the like utilizing electrostatic bonding force. In the bonding by physical adsorption, pretreatment or the like of the test object is not necessary. Therefore, it is possible to easily generate a conjugate of a reagent and a test target substance. The bonding due to the antigen-antibody reaction is, for example, specific bonding between a test target substance such as a virus and a reagent. By this bonding, it is possible to suppress generation of noise derived from impurities other than the test target substance contained in the test object. When detection of a test target substance is performed using an antigen-antibody reaction, for example, a reagent to which an antibody is bound is prepared in advance.

The optical measurement section 60 measures optical characteristics of a reaction product between the test object and the reagent supplied to the test container 2. From a measurement result of the optical measurement section 60, the presence or content of the test target substance contained in the test object is detected.

For example, the optical measurement section 60 irradiates the reaction product between the test object and the reagent with light, and detects an optical signal generated by the reactant. The optical measurement section 60 includes, for example, an irradiation section and a light receiving section.

The irradiation section includes a light source and emits light toward the test container 2 from the light source. The light emitted from the irradiation section to the test container 2 is, for example, light in a wavelength range capable of exciting the fluorescent substance. The light source is, for example, a lamp, a light emitting diode (LED), a laser, or the like. The LED is an abbreviation for Light Emitting Diode. The light generated by the light source may be monochromatic light or light having a wide wavelength band. When the light generated by the light source has a wide wavelength band, it is preferable that the irradiation section has an optical filter such as a band-pass filter. In a case where a lamp, an LED, or the like is used as the light source, it is preferable that the irradiation section includes a guide member that regulates a traveling direction of light generated in the light source. The guide member is, for example, a collimator lens or the like.

The light receiving section includes, for example, an imaging device such as a photodiode, a photodetector, a CCD image sensor, or a CMOS image sensor. The CCD is an abbreviation for a Charge Coupled Device. The CMOS is an abbreviation for Complementary Metal Oxide Semiconductor. The photodetector is, for example, a photomultiplier tube or the like. As the light receiving section, a known imaging device can be used. The light intensity or spectrum of the light incident on the optical measurement section 60 is detected by the light receiving section. The light receiving section may detect the intensity of light having a single wavelength. The light receiving section may detect the intensity of light having a plurality of wavelengths. When the light emitted from the irradiation section enters the test container 2, for example, a conjugate of the reagent and the test target substance is excited by the light to generate an optical signal. The generated optical signal enters the light receiving section.

The test object supply section 40, the reagent supply section 50, and the optical measurement section 60 are disposed side by side in the rotation direction of the test container 2, that is, in a circumferential direction of the test container 2. For example, the test object supply section 40, the reagent supply section 50, and the optical measurement section 60 are disposed counterclockwise in this order. The test object supply section 40, the reagent supply section 50, and the optical measurement section 60 may be disposed clockwise in this order.

The optical measurement section 60 may be disposed on a side opposite to the test object supply section 40 and the reagent supply section 50 with respect to the placement base 10, that is, on a lower surface side of the placement base 10. For example, the optical measurement section 60 measures the optical characteristics of the reaction product between the test object and the reagent by irradiating the test container 2 disposed immediately above the optical measurement section 60 with light.

The maintaining member 70 plays a role of maintaining a Z-direction distance between the optical measurement section 60 and the test container 2 at a predetermined value. The maintaining member 70 is provided at a predetermined position in the Z direction. For example, when the lower surface of the test container 2 is brought into contact with the maintaining member 70, the position of the test container 2 in the Z direction is maintained. At this time, the maintaining member 70 is disposed, for example, at a position facing the optical measurement section 60. The Z-direction distance between the optical measurement section 60 and the test container 2 is maintained by the maintaining member 70, and thus the observation depth is kept constant. Thus, it is possible to perform test with high accuracy. The maintaining member 70 is configured to be movable in, for example, the X direction and the Y direction. In a case where the test container 2 is moved in the Z direction together with the holder 20, the maintaining member 70 is moved to a position away from the test container 2. For example, the maintaining member 70 is driven by a motor or the like.

The releasing member 80 has, for example, a cylindrical shape extending in the Z direction. The releasing member 80 is provided between the support base 30 and the placement base 10. The releasing member 80 is attached to, for example, a lower surface of the support base 30 and extends downward from the support base 30. The releasing member 80 releases the holding of the test container 2 by the holder 20. Specifically, a downward force is applied from the cylindrical releasing member 80 to the upper surface of the test container 2 moving upward together with the holder 20, and the test container 2 is pushed down. Accordingly, the support member 22 of the holder 20 is accommodated inward from the peripheral surface of the shaft member 21, and the holding of the test container 2 by the holder 20 is released. The test container 2 released from the holding drops. In other words, the test container 2 released from the holding by the holder 20 moves in the gravity direction.

The test apparatus 1 is provided with, for example, a plurality of releasing members 80. It is preferable that the plurality of releasing members 80 are disposed at positions that are rotationally symmetric about the shaft member 21. For example, in FIG. 2, three releasing members 80 are disposed at the rotationally symmetrical positions with respect to the shaft member 21. The plurality of releasing members 80 push down the test container 2, so that the test container 2 is hardly inclined. Thus, it is possible to prevent the test object from being spilled from the test container 2 at the time of discarding. Therefore, it is possible to more effectively suppress the risk of infection at the time of discarding.

The discarding section 90 is provided, for example, at a position facing the holder 20 in the Z direction, that is, immediately below the holder 20. The discarding section 90 is a collection space for the test container 2 after the optical measurement is performed, that is, the used test container 2. The discarding section 90 is configured to be able to collect, for example, a plurality of test containers 2. The discarding section 90 includes, for example, a bag or the like for accommodating the test container 2. The test operator or the like discards the test container 2 accommodated in this bag. Accordingly, the test operator or the like can discard the test container 2 without touching the used test container 2. The discarding section 90 may include a sealing mechanism that seals a bag or the like in which the test container 2 is accommodated. For example, the sealing mechanism seals, by thermocompression bonding, an opening of the bag or the like in which the plurality of test containers 2 are accommodated. The discarding section 90 may have a spraying mechanism for spraying a disinfectant such as hypochlorous acid to the used test container 2. The discarding section 90 may have a notification mechanism for providing a notification to a test operator or the like when a predetermined number of test containers 2 have been collected.

The driver 110 drives the holder 20 in the Z direction. The driver 110 may axially rotate the shaft member 21. The driver 110 includes, for example, a motor.

The controller 120 includes, for example, one or a plurality of CPUs. The CPU is an abbreviation for Central Processing Unit. The controller 120 performs various types of processing according to a program. The controller 120 controls holding of the test container 2 and releasing of the holding by instructing the driver 110 to drive the holder 20 in the Z direction.

For example, the driver 110 moves holder 20 downward, based on an instruction from controller 120. At this time, the shaft member 21 is inserted into the hole portion of the test container 2, and the holder 20 holds the test container 2. Specifically, when a load is applied from the test container 2 to the support member 22 on the peripheral surface of the shaft member 21, the support member 22 is accommodated inward from the peripheral surface of the shaft member 21. Thus, the shaft member 21 is inserted through the test container 2. With the test container 2 through which the shaft member 21 being inserted, the support member 22 protrudes from the peripheral surface of the shaft member 21. Accordingly, the test container 2 is held between the support member 22 and the exterior member 23.

For example, the driver 110 moves the holder 20 upward according to an instruction from the controller 120. At this time, the releasing member 80 pushes down the test container 2, and the holding of the test container 2 by the holder 20 is released. Specifically, when a load is applied from the test container 2 to the support member 22 on the peripheral surface of the shaft member 21, the support member 22 is accommodated inward from the peripheral surface of the shaft member 21. Thus, the hole portion of the test container 2 comes off from the shaft member 21.

The controller 120 of the shaft member 21 may control the axial rotation of the shaft member 21. The controller 120 may control the movement of the placement base 10 in the X direction and the Y direction.

For example, the controller 120 controls holding of the test container 2 by the holder 20 and releasing of the holding based on an input signal from a test operator or the like. Alternatively, the controller 120 may control holding of the test container 2 and releasing of the holding based on a signal from a detection section. For example, the detection section detects the placement of the test container 2 on the placement base 10, so that the holder 20 holds the test container 2. For example, the detection section detects the end of the test of the test object provided in the test container 2, so that the holding of the test container 2 is released.

### Configuration of Test Container 2

The hole portion 210 which penetrates the test container 2 in the Z direction is provided in a central part of the test container 2 having a disc shape. Around the hole portion 210, for example, a plurality of receiving ports 201, a plurality of test portions 202, and a plurality of waste liquid portions 203 are provided. A set of the receiving port 201, the test portion 202, and the waste liquid portion 203 are provided in communication with each other. The receiving port 201, the test portion 202, and the waste liquid portion 203 are disposed in this order from an outer periphery toward a center of the test container 2.

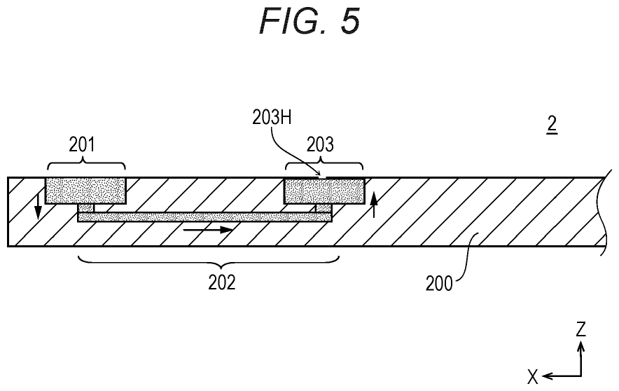

FIG. 5 illustrates an example of a cross-sectional configuration of the test container 2. This cross section is, for example, an XZ cross section. For example, the receiving port 201 and the waste liquid portion 203 are provided on the upper surface of the test container 2. The test portion 202 includes a communication path between the receiving port 201 and the waste liquid portion 203.

The receiving port 201 has a role of receiving the test object supplied from the test object supply section 40 and the reagent supplied from the reagent supply section 50 and flowing the test object and the reagent to the test portion 202. The receiving port 201 may have a funnel shape. The test object and the reagent are, for example, mixed in the receiving port 201 and then flowed to the test portion 202. The test object and the reagent may be mixed in the test portion 202. In the test container 2, for example, the plurality of receiving ports 201 are disposed in a circular shape. As the test container 2 rotates around the hole portion 210, the plurality of receiving ports 201 sequentially move to a position immediately below the test object supply section 40 and the reagent supply section 50. The test object and the reagent are supplied to each of the plurality of receiving ports 201.

The test portion 202 is irradiated with light from the optical measurement section 60. That is, an optical test of the mixture of the test object and the reagent is performed on the test portion 202. In the test container 2, for example, the plurality of test portions 202 are disposed in a circular shape. As the test container 2 rotates around the hole portion 210, the plurality of test portions 202 sequentially move to a position immediately below the optical measurement section 60. Next, optical measurement of each of the plurality of test portions 202 is performed. In this manner, since the test container 2 includes the plurality of test portions 202, a test operator does not have to replace the test container for each test object. Accordingly, it is possible to more simply perform a test.

After the optical measurement is performed in the test portion 202, the mixture of the test object and the reagent is discharged to the waste liquid portion 203. The waste liquid portion 203 is a waste liquid tank for storing the test object and the reagent after the optical measurement. An upper surface of the waste liquid portion 203 is covered with a lid member. The lid member is provided with a ventilation hole 203H. Thus, the leakage of the test object from the waste liquid portion 203 can be suppressed. In the test container 2, for example, the plurality of the waste liquid portions 203 are disposed in a circular shape.

### Operation of Test Apparatus 1

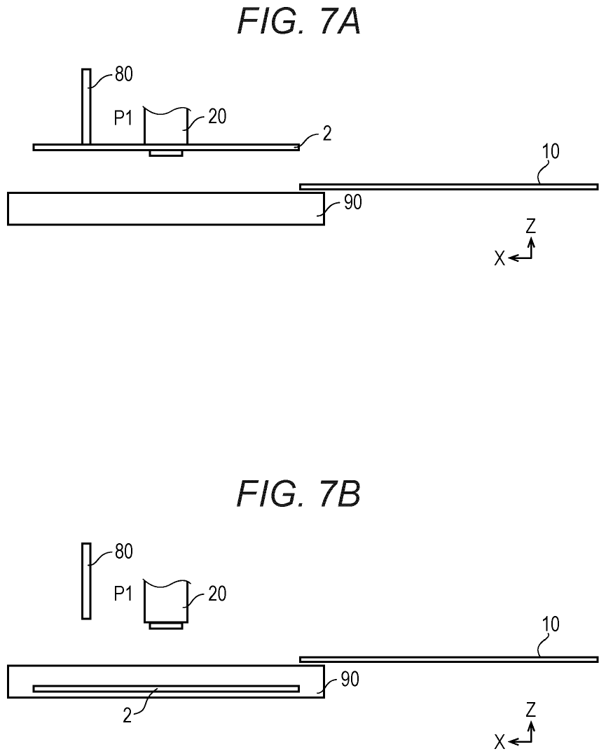

FIGS. 6A to 6D, 7A, and 7B sequentially illustrate an example of a flow of operation of the test apparatus 1. The test apparatus 1 operates, for example, as follows.

First, the test apparatus 1 disposes the holder 20 at the first position P1 in the Z direction (FIG. 6A). At this time, the placement base 10 is, for example, located at a position facing the holder 20.

Next, the test apparatus 1 moves the placement base 10, for example, in the X direction (FIG. 6B). Thus, the placement base 10 is located at a position not facing the holder 20. For example, a test operator places the test container 2 on the placement base 10.

Subsequently, the test apparatus 1 returns, to the position facing the holder 20, the placement base 10 on which the test container 2 is placed. Thereafter, the holder 20 is moved downward to be disposed at the second position P2 (FIG. 6C). Accordingly, the lower end portion of the shaft member 21 is inserted through the hole portion 210 of the test container 2. Then, the holder 20 holds the test container 2.

Next, the test apparatus 1 moves the holder 20 upward (FIG. 6D). Accordingly, the holder 20 is disposed at the third position P3 between the first position P1 and the second position P2 in the Z direction. At the third position P3 in the Z direction, the test apparatus 1 rotates the shaft member 21. Then, the test apparatus 1 performs supply of the test object and the reagent to the test container 2 and optical measurement. Specifically, the test apparatus 1 disposes the receiving port 201 at a position immediately below each of the test object supply section 40 and the reagent supply section 50 and drops the test object and the reagent. Thereafter, the test apparatus 1 disposes the test portion 202 at a position immediately below the optical measurement section 60 and performs irradiation and reception of light.

After performing the optical measurement on each of the plurality of test objects, the test apparatus 1 moves the holder 20 upward and disposes the holder 20 at the first position P1 (FIG. 7A). Thus, the releasing member 80 pushes down the test container 2, and the holding of the test container 2 is released. At this time, the test apparatus 1 disposes the placement base 10 at a position not facing the holder 20.

The test container 2 released from the holding by the holder 20 moves in the gravity direction, that is, downward, and is accommodated in the discarding section 90 (FIG. 7B). The test apparatus 1 operates, for example, in this manner to test the test object.

### Operational Effects of Test Apparatus 1

In the test apparatus 1 of the present embodiment, the controller 120 controls holding of the test container 2 and releasing of the holding, and the test container 2 released from the holding moves in the gravity direction. The test container 2 moved in the gravity direction is accommodated in the discarding section 90. Therefore, the test container 2 can be discarded without being touched by a test operator. Accordingly, it is possible to reduce the risk of infection caused by a test operator who is unfamiliar with the handling of the test object such as a biological sample touching the used test container 2. Such a test apparatus 1 is also easily installed in facilities other than a medical institution. The facilities other than the medical institution are, for example, nursing care facilities and commercial facilities.

Further, in the test apparatus 1, the discarding section 90 is provided at a position overlapping the holder 20 in plan view. Therefore, it is possible to ensure a discarding space for the test container 2 while suppressing an increase in an installation area of the test apparatus 1.

Further, the test apparatus 1 controls from holding of the test container 2 to discarding of the test container 2. Therefore, even a test operator who is unfamiliar with handling of a test object can perform a test with high accuracy and safely.

In the above embodiment, the test apparatus of the present invention has been described. However, it is needless to say that addition, deformation, and omission may be made appropriately in the present invention by those skilled in the art within the scope of the technical idea of the present invention.

For example, the above embodiment has described the example in which the waste liquid after the optical measurement is stored in the waste liquid portion 203. However, the waste liquid after the optical measurement may be stored outside the test container 2.

For example, the controller 120 described in the above embodiment may be configured by one CPU or may be configured by a plurality of CPUs.

In the above embodiment, the configuration of the holder 20 has been described using specific examples. However, the holder 20 may have another configuration. For example, the holder 20 may include a robot arm or the like.

Although embodiments of the present invention have been described and illustrated in detail, the disclosed embodiments are made for purpose of illustration and example only and not limitation. The scope of the present invention should be interpreted by terms of the appended claims.

What is claimed is:

1. A test apparatus comprising:
a holder that is capable of holding a test container in which a test object is to be provided;
a processing section that performs predetermined processing on the test object in the test container held by the holder; and
a hardware processor that controls holding of the test container by the holder and releasing of the holding,
wherein the test container released from the holding moves in a gravity direction.

2. The test apparatus according to claim 1, wherein the holder holds the test container in an axially rotatable manner.

3. The test apparatus according to claim 2, wherein the holder includes a shaft member that is to be inserted through a hole portion of the test container and that is configured to be axially rotatable.

4. The test apparatus according to claim 3, further comprising a placement base on which the test container is to be placed.

5. The test apparatus according to claim 4, wherein the holder is configured to be movable between a first position in an axial direction of the shaft member and a second position closer to the placement base than the first position is.

6. The test apparatus according to claim 5, further comprising a maintaining member that maintains a position of the test container in the axial direction.

7. The test apparatus according to claim 5, further comprising a driver which drives the holder in the axial direction,
wherein the hardware processor controls holding of the test container and releasing of the holding by instructing the driver to drive the holder in the axial direction.

8. The test apparatus according to claim 5, further comprising a releasing member that releases holding of the test container by the holder when the holder moves to the first position.

9. The test apparatus according to claim 8, wherein the releasing member presses the test container in a direction opposite to a movement direction of the holder when the holder moves to the first position.

10. The test apparatus according to claim 5, wherein the holder holds the test container when the holder moves to the second position.

11. The test apparatus according to claim 4, wherein the placement base is configured to be movable between a position facing the holder and a position not facing the holder.

12. The test apparatus according to claim 3, wherein
the holder further includes
a support member that supports the test container through which the shaft member is inserted, and
a counter member that faces the support member with the test container interposed therebetween.

13. The test apparatus according to claim 12, wherein the support member is provided on a peripheral surface of the shaft member, and protrudes from the peripheral surface of the shaft member to support the test container.

14. The test apparatus according to claim 13, wherein a plurality of the support members are provided in a rotation direction of the shaft member.

15. The test apparatus according to claim 13, wherein the support member includes a plunger.

16. The test apparatus according to claim 12, wherein the counter member includes an elastic layer on an opposite surface facing the support member.

17. The test apparatus according to claim 1, further comprising a discarding section that accommodates the test container that has moved in the gravity direction,
wherein the discarding section is provided at a position facing the holder.

18. The test apparatus according to claim 1, wherein the processing section includes an optical measurement section that performs optical measurement on the test object.

19. The test apparatus according to claim 1, wherein the test container has a disc shape in which a plurality of test portions are disposed in a circular shape.

20. A test apparatus comprising:
a holder that is capable of holding a test container in which a test object is to be provided;
a processing section that performs predetermined processing on the test object in the test container held by the holder;
a hardware processor that controls holding of the test container by the holder and releasing of the holding; and
a discarding section that receives the test container released from the holding.
